(19) United States
(12) Patent Application Publication
(10) Pub. No.: US 2016/0111760 A1
(43) Pub. Date: Apr. 21, 2016

(54) POWER STORAGE MODULE

(71) Applicant: Toyota Jidosha Kabushiki Kaisha, Toyota-shi Aichi-ken (JP)

(72) Inventor: Kunihiko Arai, Owariasahi-shi Aichi-ken (JP)

(21) Appl. No.: 14/886,588

(22) Filed: Oct. 19, 2015

(30) Foreign Application Priority Data
Oct. 21, 2014 (JP) 2014-214697

(51) Int. Cl. H01M 10/615; H01G 11/10; H01M 10/625; H01M 2/10; H01M 10/657; H01M 2/20; H01G 11/08; H01G 11/78

(52) U.S. Cl. CPC H01M 10/615; H01G 11/08; H01G 11/10; H01G 11/78; H01M 2/1077; H01M 10/657; H01M 2/206; H01M 10/625; H01M 2220/20

(57) ABSTRACT

A power storage module includes a plurality of power storage elements extending in a predetermined direction; a holder in which a plurality of openings into each of which each of the plurality of power storage elements is inserted is arranged within a plane perpendicular to the predetermined direction; a heater provided at an end portion in a first direction in the plane of the holder, and disposed linearly in a second direction perpendicular to the first direction in the plane so as to increase a temperature of the power storage elements through the holder; and a busbar unit including a first busbar dividing the plurality of power storage elements in the first direction into a plurality of blocks along the second direction and connecting the plurality of power storage elements in each block in parallel to one another, and a second busbar connecting adjacent blocks in the first direction in series to one another.

### INCORPORATION BY REFERENCE

The disclosure of Japanese Patent Application No. 2014-214697 filed on Oct. 21, 2014 including the specification, drawings and abstract is incorporated herein by reference in its entirety.

### BACKGROUND OF THE INVENTION

1. Field of the Invention

The invention relates to a power storage module including a plurality of power storage elements electrically connected to one another.

2. Description of Related Art

WO 2012/147128 discloses a battery module in which a plurality of cylindrical unit cells is held by a holder. The unit cells are connected in series or in parallel to one another, and the holder is equipped with a heater used to increase the temperature of the unit cells.

The internal resistance of the unit cells increases when the battery temperature decreases. Since an increase in internal resistance causes degradation in the input/output performance of the unit cells, the holder may be warmed by the heater so as to increase the temperature of the unit cells through the holder as in WO 2012/147128.

However, a variation in temperature occurs among the unit cells held by the holder in accordance with the heater disposing method. Particularly, when the plurality of unit cells held by the holder is divided into a plurality of blocks, the unit cells in each block are connected in parallel to one another, and the blocks are connected in series to one another, a variation in temperature occurs among the unit cells inside one block in accordance with the block dividing method and the heater disposing method.

When a variation in temperature occurs among the unit cells of the groups of the unit cells connected in parallel to one another, for example, a large amount of current flows to the high-temperature unit cell in relation to the low-temperature unit cell. Since a large amount of current flows to a specific unit cell, the battery temperature further increases in the specific unit cell in relation to the other unit cells and the degradation of the battery is promoted. For this reason, there is a need to suppress a variation in temperature among the unit cells of the groups of the unit cells connected in parallel to one another.

### SUMMARY OF THE INVENTION

An object of the invention is to provide a power storage module that increases the temperature of power storage elements by a heater through a holder having the power storage elements attached thereto and is able to increase the temperature of the power storage elements while a variation in temperature in each power storage element group is suppressed even when a plurality of power storage elements are divided into power storage element groups and the power storage element groups having the power storage elements connected in parallel to one another are connected in series to one another.

According to an aspect of the invention, the power storage module includes: a plurality of power storage elements extending in a predetermined direction; a holder in which a plurality of openings into each of which each of the plurality of power storage elements is inserted is arranged within a plane perpendicular to the predetermined direction; a heater provided at an end portion in a first direction in the plane of the holder, and disposed linearly in a second direction perpendicular to the first direction in the plane so as to increase the temperature of the power storage elements through the holder; and a busbar unit including a first busbar dividing the plurality of power storage elements in the first direction into a plurality of blocks along the second direction and connecting the plurality of power storage elements in each block in parallel to one another, and a second busbar connecting the adjacent blocks in the first direction in series to one another.

According to the aspect of the invention, in the power storage module in which the temperature of the power storage elements is increased by the heater through the holder having the plurality of power storage elements attached thereto, the heater is disposed at the end portion of the holder in the first direction so as to be linear in the second direction. Then, the plurality of power storage elements is divided into the plurality of blocks along the second direction, and each block composed of the groups of the plurality of power storage elements connected in parallel to one another is lined up and connected in series to one another in the first direction.

Since the holder is warmed by the heater, heat is transferred from the holder to the power storage elements so as to increase the temperature of the power storage elements. At this time, since the heater extends linearly along the block length in the second direction of the group of the power storage elements connected in parallel to one another and is disposed at the end portion of the holder in the first direction, a temperature distribution formed by increasing the temperature of the power storage elements by the heater is formed so as to have a temperature gradient in the first direction of the holder while a variation in temperature of the power storage elements in the second direction is suppressed.

Here, the plurality of power storage elements is divided into the plurality of blocks in the second direction. For this reason, even when a temperature distribution having a temperature gradient (a temperature difference) in the first direction of the holder is formed, the temperature difference increases among the groups of the power storage elements connected in parallel to one another. However, in the block of the groups of the power storage elements connected in parallel to one another, the temperature gradient in the first direction decreases.

Thus, it is possible to increase the temperature of the power storage elements while suppressing a variation in temperature of each group of the power storage elements lined up in the first direction in the unit of the blocks divided in the second direction when the temperature of the power storage elements is increased by the heater. Accordingly, it is possible to suppress a problem in which a large amount of current flows to a specific power storage element in the group of the power storage elements connected in parallel to one another.

Further, the heater may be provided at each of both end portions of the holder in the first direction, and the pair of heaters disposed in the second direction may be disposed so as to sandwich all power storage elements in the first direction. Since the pair of heaters is disposed so as to sandwich the power storage elements from both ends of the holder in the first direction, the heat of the heaters is uniformly transferred from both ends of the holder in the first direction toward the inside in sequence. Accordingly, it is possible to further decrease the temperature gradient in the first direction in the unit of the blocks of the groups of the power storage elements connected in parallel to one another compared with a case where the heater is provided only at one end side of the holder in the first direction.

That is, since the heat is uniformly transferred from both ends of the holder in the first direction toward the inside of the holder, the temperature gradient in which the temperature decreases from one end side of the holder in the first direction toward the other end side is not formed. Further, even when the distance from one heater in the first direction increases, the power storage elements are influenced by the heat of the other heater, and hence the temperature gradient in the first direction in the unit of the blocks decreases.

Further, the heater may be inserted into an insertion hole formed in the end portion of the holder in the first direction so as to be implanted into the holder. Since the heater is implanted into the holder, the heat may be highly efficiently transferred from the heater to the holder.

Further, the heater may extend linearly from one end side of the holder in the second direction and may be disposed in the second direction so that the end portion of the heater is located at the other end side of the holder in the second direction in relation to the substantial center portion of the block. Since the end portion of the heater extending linearly from one end side of the holder is located at the other end side of the holder in the second direction in relation to the substantial center portion of the block, it is easy to form a temperature distribution of which a variation in temperature in the second direction is suppressed.

Further, the holder may be formed in an elongated shape in the first direction. Then, a plurality of the openings may be arranged in the first direction, and a plurality of rows of the openings lined up in the first direction may be arranged in the second direction. Since the plurality of power storage elements in the longitudinal direction of the holder is divided into the plurality of blocks along the second direction even when the power storage module is formed in an elongated shape in the first direction, it is possible to increase the temperature of the power storage elements while suppressing a variation in temperature in the unit of the blocks of the groups of the power storage elements connected in parallel to one another and lined up in the first direction and the second direction within a plane when the temperature of the power storage elements is increased by the heater.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a top view of a battery module of an embodiment 1;

FIG. 2 is a cross-sectional view taken along the line Y1-Y1 of FIG. 1;

FIG. 3 is a perspective view of a configuration of a busbar unit of the embodiment 1;

FIG. 4 is a diagram illustrating a state where the battery module of the embodiment 1 is heated;

FIG. 5 is a diagram illustrating a state where a battery module of a first related art is heated;

FIG. 6 is a diagram illustrating a state where a battery module of a second related art is heated; and

FIG. 7 is a diagram illustrating a modified example of the battery module of the embodiment 1 and illustrating a state where the battery module is heated.

### DETAILED DESCRIPTION OF EMBODIMENTS

Hereinafter, an embodiment of the invention will be described.

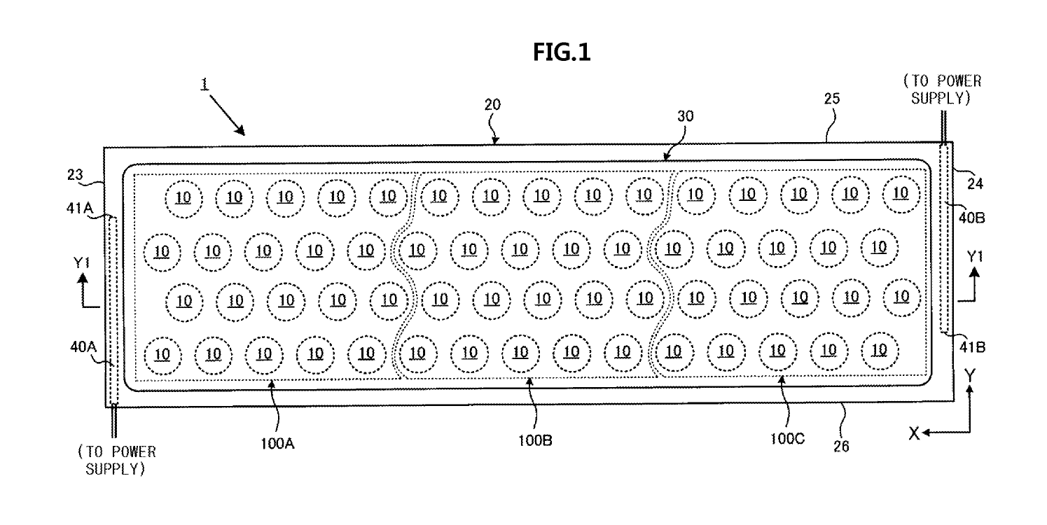

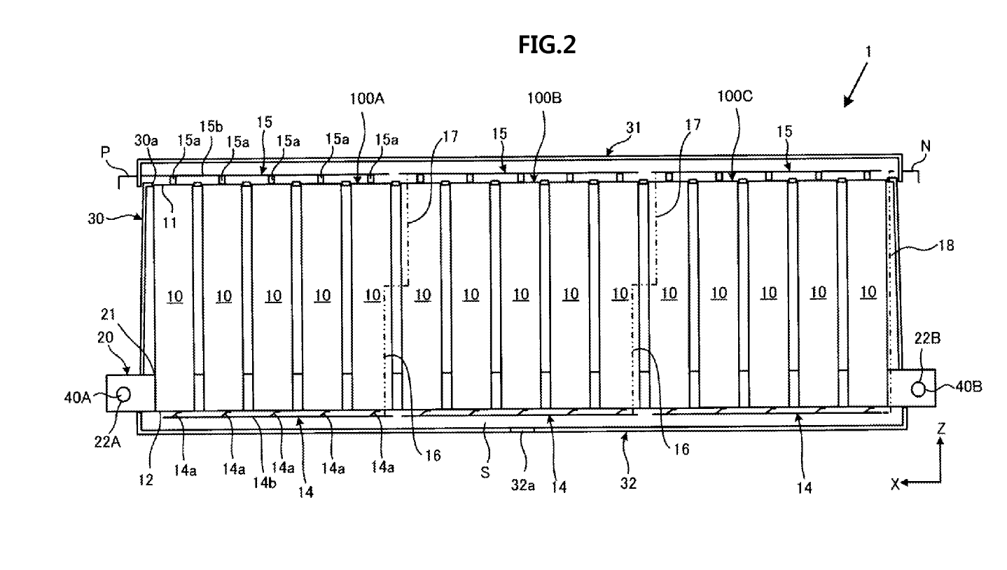

(Embodiment 1) A battery module (corresponding to a power storage module) as an embodiment 1 of the invention will be described. FIG. 1 is a top view of the battery module. FIG. 2 is a cross-sectional view taken along the line Y1-Y1 of FIG. 1. In FIGS. 1 and 2, the X axis, the Y axis, and the Z axis are axes perpendicular to one another. In the embodiment, the axis extending in the vertical direction is set as the Z axis. The relation of the X axis, the Y axis, and the Z axis is the same in the other drawings.

A battery module 1 of the embodiment may be mounted on, for example, a vehicle such as a hybrid vehicle or an electric vehicle, and is used as a power source device supplying power to a traveling motor.

The battery module 1 includes a plurality of unit cells (corresponding to power storage elements) 10. Each unit cell 10 extends in the Z direction. The plurality of unit cells 10 is arranged in a row within the X-Y plane. For example, the battery module may be formed by arranging the plurality of unit cells 10 in a first arrangement direction as the X direction and arranging the plurality of unit cells 10 arranged in the first arrangement direction in multiple stages in a second arrangement direction as the Y direction.

In addition, in the embodiment, the unit cells 10 arranged in the Y direction are deviated from one another in the X direction. The configuration is set so that many unit cells 10 are arranged in the Y direction or the length of the battery module 1 in the Y direction is shortened. Meanwhile, the unit cells 10 may be arranged so as to match one another in the Y direction while not being deviated from one another in the X direction.

The unit cell 10 is a so-called cylindrical battery, and the cross-section of the unit cell 10 in the X-Y plane is formed in a circular shape. The unit cell 10 has a configuration in which a power generating element is received inside a cylindrical battery case. As the unit cell 10, a secondary battery such as a nickel metal hydride battery or a lithium ion battery may be used. Further, an electrical double layer capacitor may be used instead of the secondary battery.

As illustrated in FIG. 2, a positive terminal 11 and a negative terminal 12 are respectively formed at both ends of the unit cell 10 in the longitudinal direction (the Z direction). A battery case as an exterior member of the unit cell 10 may be formed by a case body and a lid. Here, the unit cell 10 is formed by accommodating the power generating element into the cylindrical case body and blocking the case body by the lid.

A gasket formed of an insulation material is disposed between the lid and the case body. The lid is electrically connected to a positive electrode plate of the power generating element, and is used as the positive terminal 11 of the unit cell 10. The case body is electrically connected to a negative electrode plate of the power generating element, and is used as the negative terminal 12 of the unit cell 10. In the embodiment, an end surface of the case body facing the lid (the positive terminal 11) in the Z direction is used as the negative terminal 12, and the positive terminal 11 and the negative terminal 12 are respectively located at both ends in the Z direction.

As illustrated in FIG. 2, all unit cells 10 constituting the battery module 1 are arranged so that the positive terminals 11 are located at the upside. The positive terminals 11 of all unit cells 10 are lined up within the same plane (the X-Y plane). The same also applies to the negative terminals 12.

The unit cells 10 are held by a holder 20 as a holding member. The holder 20 is formed in an elongated shape in the X direction, and includes a plurality of openings 21 into which the unit cells 10 are respectively inserted. The opening 21 is formed in a shape (specifically, a circular shape) following the outer peripheral surface of the unit cell 10. The openings 21 are formed as many as the unit cells 10. In response to the arrangement positions of the plurality of unit cells 10, the plurality of openings 21 is arranged in the X direction and a plurality of the rows of the plurality of openings 21 arranged in the X direction is arranged in the Y direction.

The holder 20 may be formed of, for example, metal material such as aluminum having excellent heat conductivity or resin material having excellent heat conductivity. In addition, an insulator formed of an insulation material such as resin may be disposed between the unit cell 10 and the opening 21 of the holder 20.

The module case 30 is formed in a shape surrounding the plurality of unit cells 10 held by the holder 20 within the X-Y plane, and the plurality of unit cells 10 is accommodated inside the module case 30. A plurality of openings 30a is formed at an upper surface of the module case 30 located at the positive terminal 11 side of the unit cell 10. An end portion of the positive terminal 11 side of the unit cell 10 is inserted into the opening 30a. The module case 30 may be formed of an insulation material such as resin.

In addition, a plurality of slits (not illustrated) as ventilation ports may be formed at the side face of the module case 30 following the X direction. The slits may be formed at the side face of the module case 30 with a predetermined gap therebetween. For example, cooling air flows from the slits of one side face. The cooling air flows into the battery module 1 in the Y direction and flows from the slits of the other side face into the battery module 1, so that the unit cell 10 may be cooled.

An area near the negative terminal 12 side of the unit cell 10 is positioned within the X-Y plane by the opening 21 of the holder 20, and an area near the positive terminal 11 side of the unit cell 10 is positioned within the X-Y plane by the opening 30a of the module case 30. Both ends of the unit cell 10 in the longitudinal direction (the Z direction) are respectively positioned by the holder 20 and the module case 30, so that the contact of two unit cells 10 adjacent to each other within the X-Y plane is prevented.

As illustrated in FIG. 2, in the battery module 1 of the embodiment, the end portions at the negative terminals 12 side of the unit cells 10 are inserted into the openings 21, and the unit cells 10 are provided uprightly from the holder 20. Then, a busbar 14 is provided at the negative terminal 12 side of the unit cells 10 exposed from the opening 21 of the holder 20. The busbar 14 is disposed so as to be separated from the plurality of unit cells 10 (the negative terminals 12) by a predetermined distance in the Z direction. The negative terminal 12 is connected to a connection portion 14a protruding in the Z direction.

Further, a busbar 15 is provided at the positive terminal 11 side of the unit cell 10 exposed upward from the opening 30a of the module case 30. The busbar 15 is disposed so as to be separated from the plurality of unit cells 10 (the positive terminals 11) by a predetermined distance in the Z direction. The positive terminal 11 is connected to a connection portion 15a protruding in the Z direction.

The upper surface of the battery module 1 is equipped with a cover member 31 covering the busbar 15 from the upside. The cover member 31 is formed in a shape extending in the X-Y plane and covering the entire upper surface of the module case 30 to which the positive terminal 11 of the unit cell 10 is exposed. The cover member 31 may be fixed to, for example, the module case 30. The cover member 31 may be formed of resin or the like similarly to the module case 30.

Meanwhile, the lower surface of the battery module 1 is equipped with a cover member 32 covering the busbar 14. The cover member 32 is formed in a shape extending in the X-Y plane and covering the entire lower surface of the holder 20 to which the negative terminal 12 of the unit cell 10 is exposed. The cover member 32 is a metallic member that forms a gas discharge space S by covering the negative terminals 12 side of the plurality of unit cells 10 arranged within the X-Y plane. The cover member 32 may include, for example, a fixed portion (not illustrated) to be fixed to the holder 20.

The unit cell 10 of the embodiment may include a discharge valve (not illustrated) discharging a gas generated inside the unit cell 10 to the outside. The discharge valve may be provided at, for example, the bottom portion of the case body forming the negative terminal 12. The discharge valve is, for example, a rupture valve, and may be formed by a groove formed at the bottom portion of the case body forming the negative terminal 12. When the bottom portion of the case body is ruptured from the groove due to the internal pressure of the unit cell 10 increased by the generation of a gas, the internal gas may be discharged to the outside of the unit cell 10.

In the lower surface of the battery module 1, the periphery of the area in which the busbar 14 is disposed is covered by the cover member 32, and the discharge space S is formed by the lower surface of the holder 20 and the cover member 32. The cover member 32 may be equipped with a discharge port 32a of the discharge space S. A gas discharged from the inside of the unit cell 10 through the discharge valve flows through the discharge space S while contacting the cover member 32, and is discharged from the discharge port 32a to the outside of the battery module 1. A discharge pipe or the like used to communicate with the outside of the vehicle may be connected to the discharge port 32a.

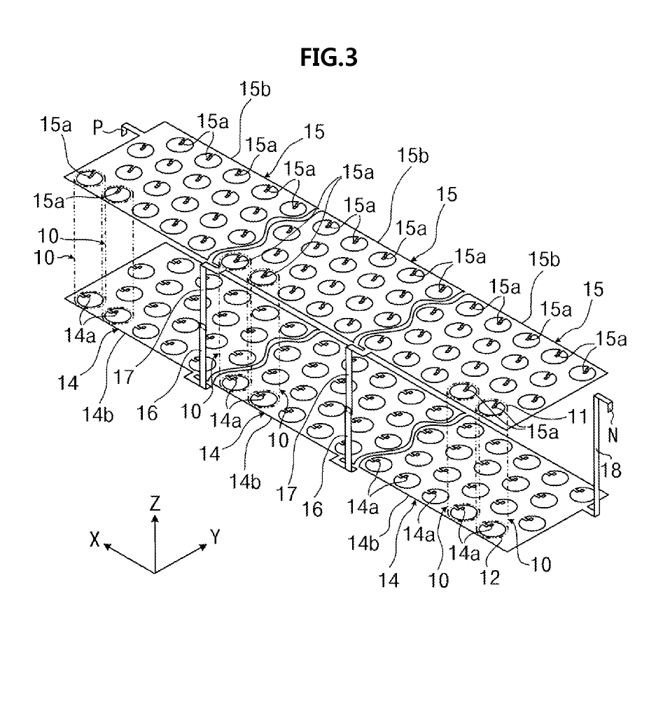

FIG. 3 is a perspective view of a configuration of a busbar unit of the embodiment. The busbar 14 is formed of a conductive material such as metal. The busbar 14 includes a plurality of connection portions 14a respectively connected to the negative terminals 12 of the unit cells 10. The connection portions 14a are formed as many as the unit cells 10 (the negative terminals 12) in the X-Y plane, and are formed at the positions facing the negative terminals 12 in the Z direction.

The busbar 14 may be formed by pressing and punching a plane plate member in the thickness (plate thickness) direction as the Z direction. The plurality of connection portions 14a is formed at the positions respectively corresponding to the arrangement positions of the unit cells 10 (the negative terminals 12) with a predetermined gap therebetween. Each connection portion 14a protruding from a plate member (base end portion 14b) in the Z direction is connected to the negative terminal 12 by welding. The entire busbar 14 as the negative busbar is tinged with negative charge of unit cells 10.

The busbar 15 is also formed of a conductive material such as metal. The connection portions 15a are formed as many as the unit cells 10 (the positive terminals 11) in the X-Y plane, and are formed at the positions facing the positive terminals 11 in the Z direction.

Similarly to the busbar 14, the busbar 15 may be formed by pressing and punching a plane plate member. Each connection portion 15a is formed in a shape protruding from a plate member (base end portion 15b) toward the positive terminal 11 of the unit cell 10. The plurality of connection portions 15a is formed as many as the unit cells 10 (the positive terminals 11) in the X-Y plane with a predetermined gap therebetween. Each connection portion 15a is connected to the positive terminal 11 by welding. The entire busbar 15 as the positive busbar is tinged with positive charge of the unit cells 10.

The connection portion 15a of the embodiment may be used as a fuse which is fused and cut so as to interrupt the electric connection with the unit cell 10 (the positive terminal 11) when a predetermined value or more of current flows. For example, the connection portion 15a may be formed so that the width is smaller than that of the connection portion 14a of the busbar 14 and the upper-limit current value for fusing characteristics decreases.

The plurality of unit cells 10 of the embodiment is lined up so that the directions of the positive terminals 11 (or the negative terminals 12) are the same in the Z direction. One busbar 14 is connected to the negative terminals 12, and one busbar 15 is connected to the positive terminals 11 of the unit cells 10, so that the plurality of unit cells 10 is electrically connected in parallel to one another. In addition, an area other than the connection portions of the busbars 14 and 15 may be covered by an insulation film.

Then, in the battery module 1 of the embodiment, a predetermined number of the unit cells 10 are connected in parallel to one another by the busbars 14 and 15 so as to form one battery block, and each battery block 100A, 100B, and 100C is connected in series to one another as illustrated in FIG. 2. In the example of FIG. 2, a state where the adjacent battery blocks 100A, 100B, and 100C are electrically connected in series through lead portions 16 and 17 is schematically indicated by the two-dotted chain line.

The lead portion 16 of the busbar 14 of the battery block 100A disposed in the X direction is connected to the lead portion 17 of the busbar 15 of the adjacent battery block 100B. Further, the lead portion 16 of the busbar 14 of the battery block 100B is connected to the lead portion 17 of the busbar 15 of the adjacent battery block 100C.

As illustrated in FIG. 3, the lead portion 16 may be formed by extending a part of the base end portion 14b of the busbar 14. The lead portion 17 may be also formed by extending a part of the base end portion 15b of the busbar 15. The lead portions 16 and 17 are formed in a thin and elongated plate shape extending in the Z direction, and are disposed at substantially the same position in the X direction. The lead portions 16 and 17 are connected to each other by welding. In addition, the lead portion 16 is disposed at the outside of a Y-direction end portion 26 of the holder 20 while the busbars 14 and 15 are attached to the unit cells 10 inserted into the holder 20.

The busbar unit of the embodiment includes the pair of busbars 14 and 15 (corresponding to first busbars) connecting the plurality of unit cells 10 inside each battery block in parallel to one another and the lead portions 16 and 17 (corresponding to second busbars) connecting one busbar 14 of the adjacent battery block to the other busbar 15 thereof in the pair of busbars 14 and 15 provided for each of the plurality of battery blocks lined up in the X direction.

The terminal ends of the plurality of battery blocks connected in series to one another are formed as the electrode terminals of the battery module 1. In the example of FIG. 2, a positive electrode P of the battery module 1 may be drawn out by extending a part of the busbar 15 of the battery block 100A located at one end in the X direction. Further, a negative electrode N of the battery module 1 may be drawn out by extending a part of the busbar 14 of the battery block 100C located at the other end in the X direction.

The positive electrode P and the negative electrode N of the battery module 1 are respectively disposed at both end portions of the battery module 1 in the X direction and protrude outward from the module case 30 (the cover member 31) in the X direction.

In addition, since the busbar 14 of the battery block 100C is disposed at the lower surface side of the battery module 1, for example, an extension portion 18 which extends to the upper surface side of the battery module 1 may be formed as illustrated in FIGS. 2 and 3. Further, the positive electrode P and the negative electrode N may not be formed by extending a part of the busbars 14 and 15, but may be separate electrode terminals respectively connected to the busbars 14 and 15.

In the battery module 1 of the embodiment, the plurality of unit cells 10 held by the holder 20 is divided into the plurality of battery blocks 100A, 100B, and 100C, and the battery blocks 100A, 100B, and 100C are connected in series to one another. The plurality of unit cells 10 that belongs to each battery block is connected in parallel to one another. In one battery block, five unit cells 10 arranged in line in the X direction are lined up in four stages in the Y direction, and the number of the unit cells 10 included in each battery block is the same. In addition, the number of the unit cells 10 included in one battery block and the arrangement direction of the unit cells 10 may be appropriately set.

Then, in the embodiment, a pair of heaters 40A and 40B is provided as a temperature adjustment unit of the battery module 1. The heaters 40A and 40B are heating units increasing the temperature of each unit cell 10 through the holder 20, and are driven by power supplied from a power supply source (not illustrated). As illustrated in FIG. 1, the heaters 40A and 40B extending linearly in the Y direction are respectively provided at both X-direction end portions (23 and 24) of the holder 20, and are disposed so as to sandwich all unit cells 10 attached to the holder 20 in the X direction.

Insertion holes 22A and 22B into which the heaters 40A and 40B are implanted are respectively formed at the X-direction end portions of the holder 20. The insertion holes 22A and 22B are formed inside the holder 20 so as to extend from one end side toward the other end side in the Y direction at different positions.

Here, the insertion hole 22A linearly extends from the Y-direction end portion 26 toward the Y-direction end portion 25 of the holder 20, and an end portion 41A of the heater 40A is formed so as to be located at the Y-direction end portion 25 side in relation to the substantial center portion of the block length of the battery block 100A in the Y direction. Similarly, the insertion hole 22B linearly extends from the Y-direction end portion 25 toward the Y-direction end portion 26 of the holder 20, and an end portion 41B of the heater 40B is formed so as to be located at the Y-direction end portion 26 side in relation to the substantial center portion of the block length of the battery block 100C in the Y direction. In addition, the heaters 40A and 40B may be respectively disposed so as to extend linearly from one end portion toward the other end portion in the Y direction.

In addition, the heaters 40A and 40B may be provided so as to be implanted into the holder 20 or to be attached to the outer surface of the holder 20. However, in the embodiment, the heaters 40A and 40B are not attached to outer surface of the holder 20, but are implanted into the holder 20 in order to improve the heat transfer efficiency between the holder 20 and each of the heaters 40A and 40B.

As the power supply source of the heaters 40A and 40B, for example, an auxiliary battery mounted on the vehicle or an external power supply such as a commercial power supply connected during external charging may be exemplified. The supply of power to the heaters 40A and 40B may be controlled by a control unit (not illustrated) mounted on the vehicle. The control unit may carry out on/off control of a current path using a switch between the heaters 40A and 40B and the power supply source or control of the power supply to the heaters 40A and 40B using a DC/DC converter or the like.

The heaters 40A and 40B of the embodiment are attached to the holder 20. As described above, the holder 20 holds the plurality of unit cells 10 while one end side of the unit cell 10 is inserted into the opening 21. The holder 20 serves as a thermal diffusion member of each unit cell 10 and serves as a heat transfer member that transfers the heat of the heaters 40A and 40B to the unit cell 10. In the embodiment, since the holder 20 may be warmed by the heaters 40A and 40B, heat is transferred from the holder 20 to the unit cells 10 so that the temperature of the unit cell 10 increases.

The internal resistance of the unit cell 10 increases when the battery temperature decreases. The input/output performance of the unit cell 10 decreases when the internal resistance increases. For this reason, since the unit cells 10 are heated by the heaters 40A and 40B, it is possible to improve the battery output performance when power is supplied to a load or to improve the battery input performance when power is regenerated or the battery is charged externally.

However, a variation in temperature occurs among the unit cells 10 held by the holder 20 in accordance with the arrangement method of the heaters 40A and 40B. Particularly, when the plurality of unit cells 10 held by the holder 20 is divided into the plurality of battery blocks, the unit cells 10 inside each battery block are connected in parallel to one another, and the battery blocks are connected in series to one another, a variation in temperature occurs among the unit cells 10 inside one battery block in accordance with the arrangement positions of the heaters 40A and 40B and the method of dividing the battery blocks.

When a variation in temperature occurs among the unit cells 10 in the group of the unit cells 10 connected in parallel to one another, for example, a large amount of current flows in the high-temperature unit cells 10 in relation to the low-temperature unit cells 10. Since a large amount of current flows in the specific unit cell 10, the battery temperature further increases and the degradation of the battery is promoted in the specific unit cells 10 in relation to the other unit cells 10. For this reason, there is a need to suppress a variation in temperature among the unit cells 10 of the group of the unit cells 10 connected in parallel to one another.

Here, in the battery module 1 of the embodiment, the heaters 40A and 40B are disposed linearly in the Y direction at the X-direction end portion of the holder 20 in the structure in which the temperature of the unit cell 10 increases through the holder 20 equipped with the plurality of unit cells 10 using the heaters 40A and 40B. Then, the plurality of unit cells 10 is divided into the plurality of battery blocks along the Y direction, and the battery blocks each including the group of the plurality of unit cells 10 connected in parallel to one another are arranged in the X direction, and are connected in series to one another.

Since the heaters 40A and 40B extend linearly along the block length in the Y direction of the group of the unit cells 10 connected in parallel to one another and are disposed at the X-direction end portion of the holder 20, the temperature distribution formed by the temperature of the unit cells increased by the heaters 40A and 40B is formed so as to have the temperature gradient (the temperature difference) in the X direction of the holder 20 while a variation in temperature of the unit cells in the Y direction is suppressed.

Here, the plurality of unit cells 10 is divided into the plurality of battery blocks along the Y direction in which the heaters 40A and 40B extend linearly. For this reason, even when a temperature distribution having a temperature difference in the X direction of the holder 20 is formed, the temperature difference among the groups of the unit cells 10 connected in parallel to one another increases, but, the temperature gradient in the X direction decreases in the block of the groups of the unit cells 10 connected in parallel to one another.

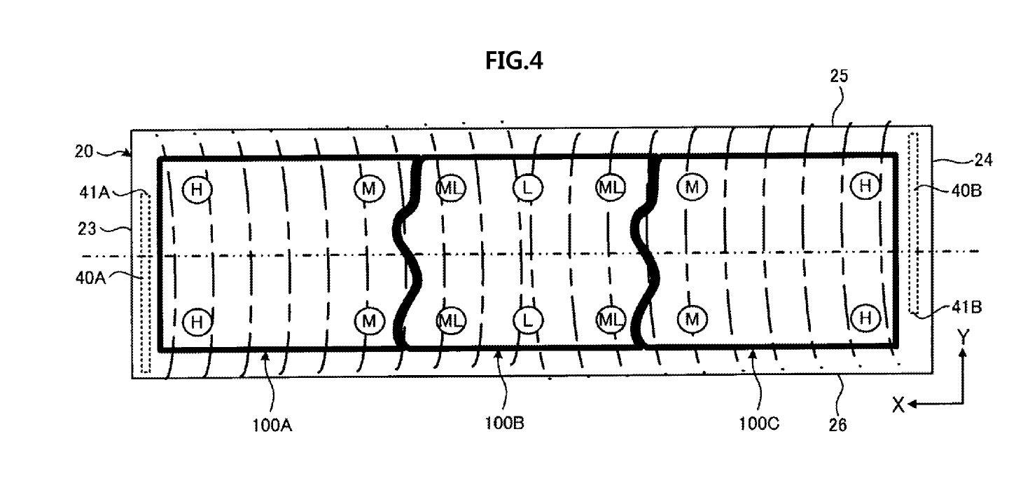

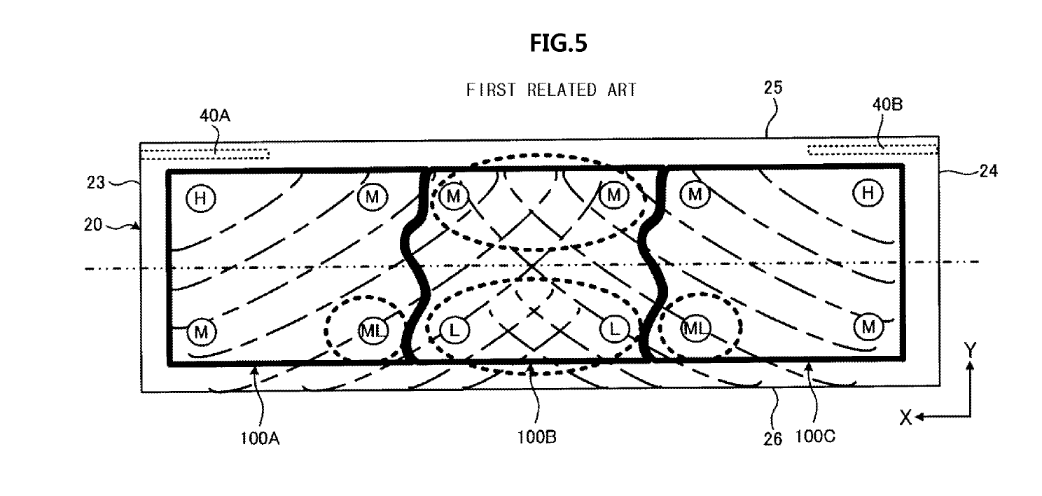

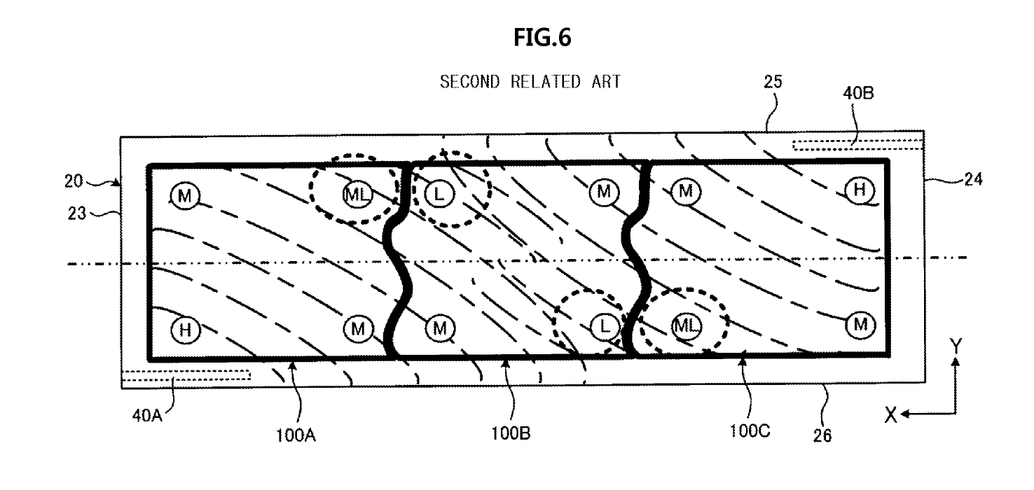

FIG. 4 is a diagram illustrating a state where the battery module 1 of the embodiment is heated. In the example of FIG. 4, the one-dotted chain line indicates a state where heat is transferred from the heaters 40A and 40B to the holder 20. Further, the two-dotted chain line indicates the center of the block length in the Y direction of the battery block, and the same also applies to the examples of FIGS. 5 and 6 to be described later.

As illustrated in FIG. 4, since the heaters 40A and 40B extend linearly in the Y direction, a variation in temperature in the Y direction is suppressed, and a uniform temperature distribution is formed in substantially parallel in the Y direction.

A temperature gradient is formed in which the temperature decreases as it goes from the heater 40A toward the inside of the holder 20 in the X direction of the holder 20. However, the plurality of unit cells 10 is divided into the plurality of battery blocks in the X direction, and the battery blocks 100A, 100B, and 100C are lined up in the X direction.

For this reason, it is possible to decrease the temperature gradient in the X direction in each battery block. For example, in FIG. 4, H (High), M (Medium), ML (Medium-Low), and L (LOW) indicate the temperature degree of the unit cell 10 increased in temperature through the holder 20 by the heat transferred from the heaters 40A and 40B. The temperature degrees decrease in order of H (High), M (Medium), ML (Medium-Low), and L (LOW).

As illustrated in FIG. 4, in the battery block 100A adjacent to the heater 40A, the temperature near the heater 40A is high (“H”), and the temperature decreases as it goes from the heater 40A toward the inside of the holder. However, the temperature at the position farthest from the heater 40A becomes “M” inside the battery block 100A divided along the Y direction. Similarly, even in the battery block 100C adjacent to the heater 40B, the temperature near the heater 40B increases to “H”, and the temperature at the position farthest from the heater 40B becomes “M”.

Then, the temperature near the X-direction end portion of the battery block 100B becomes a temperature (“ML”) lower than the adjacent battery blocks 100A and 100C due to the influence of the heat of the heaters 40A and 40B, and the temperature at the center portion of the battery block 100B in the X direction becomes “L” since the center portion is farthest from the heaters 40A and 40B in the X direction. As a result, the temperature at the center portion becomes the lowest temperature in the X direction.

Likewise, the temperature gradient between one end side and the other end side of each of the battery blocks 100A and 100C in the X direction changes from “H” to “M”, and the temperature gradient between one end side and the other end side of the battery block 100B in the X direction changes from “ML” to “L”.

Meanwhile, FIGS. 5 and 6 are diagrams illustrating a state where the battery modules 1 of a first related art and a second related art are heated by the heater. First, in the first related art illustrated in FIG. 5, the heaters 40A and 40B are provided so as to be substantially parallel to the arrangement direction of the battery blocks lined up in the X direction. At this time, two heaters 40A and 40B are disposed only at the Y-direction end portion 25 side. In addition, even in the examples of FIGS. 5 and 6, the one-dotted chain line indicates a state where heat is transferred from the heaters 40A and 40B to the holder 20.

In the drawing paper of FIG. 5, a low-temperature area (“ML”) is formed at the right lower area farthest from the heater 40A and a high-temperature area (“H”) is formed at the left upper area closest to the heater 40A in the battery block 100A closest to the heater 40A. At this time, the temperature gradient (the temperature difference) among the unit cells 10 inside the battery block 100A changes from “H” to “ML”, and the temperature gradient increases compared with the example of FIG. 4. The same also applies to the battery block 100C.

Particularly, in the battery block 100B sandwiched between the battery blocks 100A and 100C, the temperature at the upper side of the drawing paper close to the Y-direction end portion equipped with the heaters 40A and 40B is high, but the temperature at the lower side of the drawing paper farthest from each of the heaters 40A and 40B decreases. The temperature gradient (the temperature difference) among the unit cells 10 inside the battery block 100B changes from “M” to “L”, and the temperature gradient increases compared with the example of FIG. 4.

Thus, a low-temperature area and a high-temperature area indicated by the bold dotted line are formed among the unit cells 10 connected in parallel to one another inside the battery blocks 100A and 100C, and a low-temperature area and a high-temperature area indicated by the bold dotted line are also formed inside the battery block 100B.

Further, in the second related art illustrated in FIG. 6, the heaters 40A and 40B are provided so as to be substantially parallel to the arrangement direction of the battery blocks 100A, 100B, and 100C lined up in the X direction. At this time, two heaters 40A and 40B are disposed in the X direction of the holder 20, and are separately disposed at the Y-direction end portions 25 and 26 side.

As illustrated in FIG. 6, a low-temperature area is formed at the right upper area farthest from the heater 40A and a high-temperature area is formed at the left lower area closest to the heater 40A in the battery block 100A closest to the heater 40A. Also, a low-temperature area is formed at the left lower area farthest from the heater 40B and a high-temperature area is formed at the right upper area closest to the heater 40B in the battery block 100C.

For this reason, even in the example of FIG. 6, the temperature gradient (the temperature difference) among the unit cells 10 inside each of the battery blocks 100A and 100C changes from “H” to “ML”, and the temperature gradient increases compared with the example of FIG. 4. Further, in the battery block 100B, the temperature of the left lower area of the drawing paper at the Y-direction end portion 26 side closest to the heater 40A increases, and the temperature of the left upper area of the drawing paper at the Y-direction end portion 25 side farthest from the heaters 40A and 40B decreases. Similarly, the temperature of the right upper area of the drawing paper at the Y-direction end portion 25 side closest to the heater 40B increases, and the temperature of the right lower area of the drawing paper at the Y-direction end portion 26 side farthest from the heaters 40A and 40B decreases.

Thus, even in the second related art, a low-temperature area and a high-temperature area indicated by the bold dotted line are formed among the unit cells 10 connected in parallel to one another inside the battery blocks 100A and 100C, and a low-temperature area and a high-temperature area indicated by the bold dotted line are also formed inside the battery block 100B.

Likewise, the battery module 1 of the embodiment may increase the temperature of the unit cells while suppressing a variation in temperature in each group of the unit cells 10 lined up in the X direction in the unit of the blocks divided along the Y direction when the temperature of the unit cells is increased by the heaters 40A and 40B. Accordingly, it is possible to suppress a large amount of current to the specific unit cell 10 in the group of the unit cells 10 connected in parallel to one another.

Further, the heaters 40A and 40B are respectively provided at both X-direction end portions of the holder 20, and the pair of heaters 40A and 40B disposed in the Y direction is disposed so as to sandwich all unit cells 10 from both sides in the X direction. Since the pair of heaters 40A and 40B is disposed so as to sandwich all unit cells from both X-direction end portions of the holder 20, the heat generated by the heaters 40A and 40B is uniformly transferred from both X-direction end portions of the holder 20 toward the inside of the holder in sequence. Accordingly, it is possible to further decrease the temperature gradient in the X direction inside each block of the group of the unit cells 10 connected in parallel to one another compared with a case where the heater is provided only at one X-direction end portion of the holder 20.

More specifically, since heat is uniformly transferred from both X-direction ends of the holder 20 toward the inside in sequence, the temperature gradient in one direction decreasing from one X-direction end side on of the holder 20 toward the other X-direction end side thereof is not formed. Accordingly, even when the position is distant from one heater 40A in the X direction, there is an influence of heat from the other heater 40B, and hence the temperature gradient in the X direction in the unit of the battery block decreases.

Further, since the end portions 41A and 41B of the heaters 40A and 40B extending linearly in the Y direction are formed so as to be located at the other end (25, 26) side of the holder 20 in relation to the substantial center portion of the battery block from one end (26, 25) side of the holder 20, it is easy to form a temperature distribution of which a variation in temperature in the Y direction is suppressed. In addition, the heaters 40A and 40B may be formed so as to extend from one end (26, 25) side of the holder 20 to the other end (25, 26) side of the holder 20.

Further, the holder 20 is formed in an elongated shape in the X direction, but the plurality of unit cells 10 is divided into the plurality of blocks in the Y direction in the longitudinal direction of the holder. For this reason, it is possible to increase the temperature of the unit cells while suppressing a variation in temperature in the unit of the blocks of the groups of the unit cells 10 lined up in the X direction and the Y direction and connected in parallel to one another when the temperature of the unit cells is increased by the heaters 40A and 40B. Particularly, since the pair of heaters 40A and 40B is disposed in the elongated holder 20 (the battery module 1) so as to sandwich the plurality of unit cells from both X-direction end portions of the holder 20, it is possible to further decrease the temperature gradient in the X direction in the unit of the blocks of the groups of the unit cells 10 connected in parallel to one another and to decrease a variation in temperature among the battery blocks 100A, 100B, and 100C lined up in the X direction.

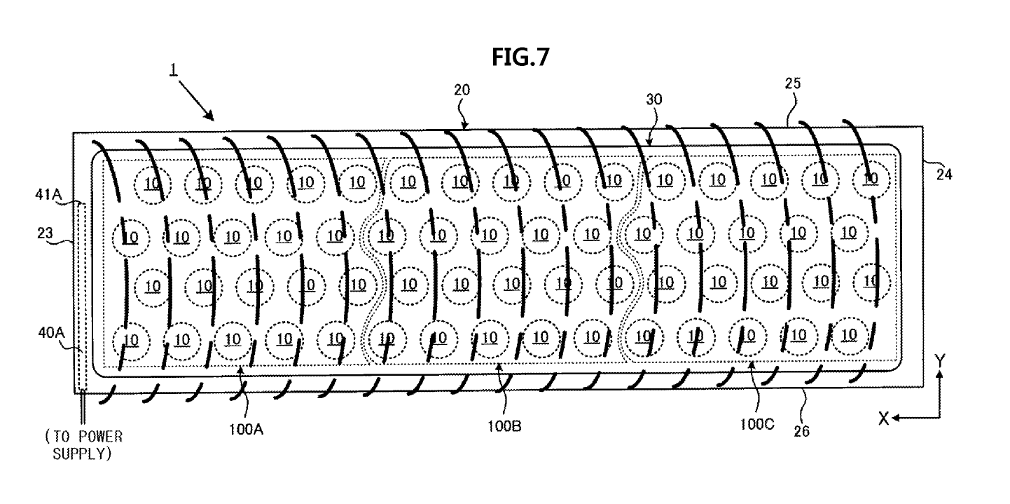

Next, a modified example of the embodiment will be described with reference to FIG. 7. FIG. 7 is a diagram illustrating a state where the battery module 1 is heated. In the modified example, the heater 40A is provided only at one end side of the holder 20 in the X direction, and the heater 40B is not provided at the other end side thereof. In addition, the one-dotted chain line indicates a state where heat is transferred from the heater 40A to the holder 20.

As illustrated in FIG. 7, since the heater 40A extends linearly in the Y direction, a variation in temperature in the Y direction is suppressed, so that a uniform temperature distribution is formed so as to be substantially parallel to the Y direction. At this time, the temperature gradient is formed in which the temperature decreases as it goes from the X-direction end portion 23 equipped with the heater 40A toward the other X-direction end portion 24.

However, in the battery module 1 of the embodiment, the plurality of unit cells 10 is divided into the plurality of battery blocks in the X direction, and the battery blocks 100A, 100B, and 100C are lined up in the X direction. For this reason, the temperature decreases as it goes away from the heater 40A so that a variation in temperature among the battery blocks 100A, 100B, and 100C increases. However, it is possible to decrease the temperature gradient in the X direction in the unit of the battery blocks as illustrated in FIG. 4.

Even when only the linear heater 40A is disposed in the Y direction in this way, since the plurality of unit cells 10 is divided along the Y direction and the groups of the unit cells 10 connected in parallel to one another are lined up in the X direction, the temperature gradient in the X direction in the unit of the battery blocks is decreased. Accordingly, it is possible to increase the temperature while suppressing a variation in temperature of each group of the unit cells 10 connected in parallel to one another in the X direction in the unit of the battery blocks divided along the Y direction when the temperature is increased only by the heater 40A.

While the embodiment of the invention has been described, the group of the unit cells 10 connected in parallel to one another in the battery module 1 may be divided into four or more groups of the unit cells 10 instead of three groups of the unit cells 10. In this case, since the block length of each battery block in the X direction is shortened as the number of the divided groups in the X direction, that is, the number of the groups of the unit cells 10 connected in series to one another in the X direction increases, it is possible to further decrease a variation in temperature inside one battery block in the X direction. In addition, the number of the pair of busbars 14 and 15 constituting the busbar unit illustrated in FIG. 3 may be increased in response to the number of the divided groups.

Further, in the battery module 1, the holder 20 is formed in an elongated shape in the X direction, but may be formed in an elongated shape in the Y direction or a substantially square shape. Even in such a case, when the heaters 40A and 40B are disposed linearly in the Y direction, the plurality of unit cells 10 is divided along the Y direction, and the groups of the unit cells 10 connected in parallel to one another are lined up in the X direction, it is possible to increase the temperature while suppressing a variation in temperature of each group of the unit cells 10 connected in parallel to one another and lined up in the X direction in the unit of the battery blocks divided along the Y direction.

Furthermore, in the battery module 1, for example, the holder 20 may be provided at the upper side of the battery module 1 instead of the lower side of the battery module 1. In this case, the discharge space S may be formed between the holder 20 and the cover member 32 disposed above the holder 20 in response to the holder 20 provided at the upper position. Similarly to the above-described embodiment, the heaters 40A and 40B may be provided at the X-direction end portions of the holder 20 so as to be linear in the Y direction.

Further, in the plurality of unit cells 10, one Z-direction end at the negative terminal 12 side is held by the holder 20, but, for example, each unit cell 10 may be inserted into the opening 21 so that the substantial center portion of the unit cell 10 in the Z direction is held.

What is claimed is:

1. A power storage module including:
a plurality of power storage elements extending in a predetermined direction;
a holder in which a plurality of openings into each of which each of the plurality of power storage elements is inserted is arranged within a plane perpendicular to the predetermined direction;
a heater provided at an end portion in a first direction in the plane of the holder, and disposed linearly in a second direction perpendicular to the first direction in the plane so as to increase a temperature of the power storage elements through the holder; and
a busbar unit including a first busbar dividing the plurality of power storage elements in the first direction into a plurality of blocks along the second direction and connecting the plurality of power storage elements in each block in parallel to one another, and a second busbar connecting adjacent blocks in the first direction in series to one another.

2. The power storage module according to claim 1,
wherein the heater is provided at each of both end portions of the holder in the first direction, and
wherein the pair of heaters disposed in the second direction is disposed so as to sandwich all of the plurality of power storage elements in the first direction.

3. The power storage module according to claim 1,
wherein the heater is inserted into an insertion hole formed in the end portion of the holder in the first direction so as to be implanted into the holder.

4. The power storage module according to claim 1,
wherein the heater extends linearly from one end side of the holder in the second direction and is disposed in the second direction so that the end portion of the heater is located at the other end side of the holder in the second direction in relation to a substantial center portion of the block.

5. The power storage module according to claim 1,
wherein the holder is formed in an elongated shape in the first direction, the plurality of openings is arranged in the first direction, and a plurality of rows of the openings lined up in the first direction is arranged in the second direction.
